(19) United States
(12) Patent Application Publication
(10) Pub. No.: US 2010/0171966 A1
(43) Pub. Date: Jul. 8, 2010

(54) ALIGNMENT APPARATUS FOR SEMICONDUCTOR WAFER

(76) Inventors: Masayuki Yamamoto, Osaka (JP); Kenji Nonomura, Kameyama-shi (JP); Satoshi Ikeda, Kameyama-shi (JP)

Correspondence Address: Cheng Law Group, PLLC, 1100 17th Street, N.W., Suite 503, Washington, DC, 20036, US

(21) Appl. No.: 12/648,565

(22) Filed: Dec. 29, 2009

(30) Foreign Application Priority Data
Jan. 8, 2009 (JP) 2009-002311

(51) Int. Cl. G01B 11/14

(52) U.S. Cl. 356/614; 901/14

(57) ABSTRACT

An alignment apparatus of this invention includes a holding stage that is larger in size than a semiconductor wafer, and an optical sensor that optically detects a position of a peripheral edge of the semiconductor wafer placed on and suction-held by the holding stage. The holding stage has a slits formed thereon vertically in a circumferential direction, and an outer periphery of the semiconductor wafer lies on the slits. The optical sensor is of a transparent type and includes a projector and a photodetector opposed vertically to each other with the slit interposed therebetween. The optical sensor measures the peripheral edge of the semiconductor wafer on the slits of the holding stage.

### BACKGROUND OF THE INVENTION

1. Field of the Invention

The present invention relates to an alignment apparatus that performs alignment on a semiconductor wafer, based on information about a peripheral edge of the semiconductor wafer and a portion for alignment (an alignment mark), such as a notch or an orientation mark, formed on the semiconductor wafer.

2. Description of the Related Art

As disclosed in Japanese Patent No. 3,820,278, for example, a conventional alignment apparatus for a semiconductor wafer (hereinafter, simply referred to as a “wafer”) has the following configuration. That is, an optical sensor measures a position of a peripheral edge of a wafer placed on and suction-held by a holding stage to detect a position of a center of the wafer and a phase position of a portion for alignment, such as a notch or an orientation mark, formed on an outer periphery of the wafer.

In the alignment apparatus, the wafer is transferred onto the holding stage in such a manner that a horseshoe-shaped suction-holding part provided at a tip end of a robot arm suction-holds the wafer. Herein, the holding stage has a disc shape which is smaller in diameter than the wafer, and therefore does not obstruct a path of the suction-holding part. Accordingly, the wafer placed on the holding stage protrudes radially from the holding stage.

Recently, a wafer is thinned increasingly, and therefore is prone to be bent. When such a thinned wafer is placed on and held by the holding stage which is smaller in diameter than the wafer, an outer periphery thereof protrudes radially from the holding stage and then is bent downward because of a self weight. Consequently, a peripheral edge of the wafer is displaced toward a center of the wafer. In the case where the optical sensor measures the position of the peripheral edge of the wafer to detect the position of the center of the wafer, this displacement disadvantageously results in an erroneous measured value.

### SUMMARY OF THE INVENTION

The present invention is directed to accurately perform alignment on a semiconductor wafer.

Additional features of the present invention will be set forth in the description which follows, and in part will be apparent from the description, or may be learned by practice of the invention.

The present invention discloses an alignment apparatus for performing alignment on a semiconductor wafer, based on information about a peripheral edge of the semiconductor wafer.

This alignment apparatus includes: a holding stage that is larger in size than a semiconductor wafer; an optical sensor that optically detects a position of a peripheral edge of the semiconductor wafer placed on and suction-held by the holding stage; a driving mechanism that turns the holding stage; and a control section that performs alignment on the semiconductor wafer, based on the position detected by the optical sensor.

According to this alignment apparatus, when the semiconductor wafer is transferred to the holding stage, the holding stage entirely suction-holds a flat back face of the semiconductor wafer which is not bent. Accordingly, the optical sensor can accurately detect the position of the peripheral edge of the semiconductor wafer without an influence of deformation due to bending of the semiconductor wafer.

Based on the detected position of the peripheral edge of the semiconductor wafer, the control section performs a predetermined arithmetic operation to obtain a position of a center of the semiconductor wafer. Based on the obtained position, moreover, the control section allows the holding stage to horizontally move in two directions which are orthogonal to each other to correct the position of the center of the semiconductor wafer to a preset reference position.

Moreover, the control section turns the holding stage, based on a result of detection of a portion for alignment, such as a notch or an orientation mark, formed on an outer periphery of the semiconductor wafer to correct a position of the portion for alignment to a preset reference phase position.

In the alignment apparatus described above, for example, the holding stage has a plurality of slits formed thereon vertically in a circumferential direction such that an outer periphery of the semiconductor wafer lies on the slits, and the optical sensor is of a transparent type and includes a projector and a photodetector opposed to each other with the slit interposed therebetween.

According to this configuration, when the semiconductor wafer is transferred to the holding stage, the holding stage entirely suction-holds the flat back face of the semiconductor wafer which is not bent in the state that the outer periphery of the semiconductor wafer lies on the plurality of slits formed in the circumferential direction. In this case, the outer periphery of the semiconductor wafer on the slits is not placed on the holding stage. However, since the slits has a narrow width, there is no possibility that the semiconductor wafer becomes deformed because of the slits into which the outer periphery of the semiconductor wafer is bent. Accordingly, the holding stage can hold the semiconductor wafer in the state that the entire back face of the semiconductor wafer is flat.

In this state, the control section turns the holding stage to detect a position of the peripheral edge of the semiconductor wafer that lies on the slits. Based on the detected position, the control section obtains the position of the center of the semiconductor wafer. In other words, the control section allows the holding stage to horizontally move in the two directions which are orthogonal to each other to correct the position of the center of the semiconductor wafer to the preset reference position. During the period that the holding stage rotates, a CCD camera or the like may scan the peripheral edge of the semiconductor wafer to detect the phase position of the notch or the orientation mark. This phase position may be employed as information for correcting the direction of the semiconductor wafer.

In the alignment apparatus described above, the holding stage has a cutout portion formed thereon such that a suction holding part provided at a tip end of a robot arm for transport of the semiconductor wafer vertically moves along the cutout portion.

According to this configuration, the semiconductor wafer is transferred to the holding stage in such a manner that the suction holding part of the robot arm suction-holds the semiconductor wafer. Herein, the suction holding part moves downward along the cutout portion of the holding stage to place the semiconductor wafer on the holding stage. Thereafter, the suction holding part of the robot arm moves to a position under the holding stage and returns to an original position thereof, and the holding stage suction-holds the semiconductor wafer placed thereon. Thus, the optical sensor starts to detect the position of the peripheral edge of the semiconductor wafer.

In the alignment apparatus described above, the cutout portion vertically penetrates through the holding stage.

According to this configuration, the semiconductor wafer is transferred to the holding stage in a state that the notch formed on the peripheral edge of the semiconductor wafer is superimposed on an arm portion of the robot arm, so that the notch of the semiconductor wafer lies on the cutout portion. Thus, the optical sensor can detect the phase position of the notch on the cutout portion. Accordingly, this configuration requires no CCD camera for detecting the notch.

In the alignment apparatus described above, the holding stage has a region where at least the outer periphery of the semiconductor wafer is placed, the region being made of a transparent material, and the optical sensor is of a transparent type and includes a projector and a photodetector opposed vertically to each other with the holding stage interposed therebetween.

This configuration is effective in a case where a semiconductor wafer having s surface to which a protective tape is joined is transferred from and to the holding stage in such a manner that a suction pad for transport suction-holds the surface of the semiconductor wafer, which is directed upward, from above.

In this case, the holding stage entirely holds the semiconductor placed thereon; therefore, the optical sensor can scan the entire peripheral edge of the semiconductor wafer which is not bent. Accordingly, this configuration allows simultaneous detection of the position of the peripheral edge of the semiconductor wafer and the phase position of the notch or the orientation mark.

In the alignment apparatus described above, the holding stage includes a center portion where a center of the semiconductor wafer is placed, and a ring-shaped periphery portion that is made of a transparent material and surrounds the center portion, and the center portion and the wafer outer periphery placement portion relatively move upward and downward such that the holding stage is switched between a wafer transfer state in which the center portion protrudes upward from the wafer outer periphery placement portion and a wafer placement state in which the center portion and the wafer outer periphery placement portion are flush with each other.

This configuration is effective in a case where a semiconductor wafer having s surface to which no protective tape is joined is transferred from and to the holding stage in such a manner that a horseshoe-shaped suction holding part provided at a tip end of a robot arm suction-holds a back face of the semiconductor wafer, which is directed upward, from below.

In this case, first, the holding stage is in the wafer transfer state in which the center portion protrudes upward from the wafer outer periphery placement portion. In this state, the robot arm places the semiconductor wafer on the protruding center portion. Next, the robot arm returns to an original position thereof, and the center portion and the wafer outer periphery placement portion relatively move upward and downward. Thus, the holding stage is in the wafer placement state in which the center portion and the wafer outer periphery placement portion are flush with each other.

As a result, the holding stage entirely holds the semiconductor wafer placed thereon; therefore, the optical sensor can scan the entire peripheral edge of the semiconductor wafer which is not bent. Accordingly, this configuration allows simultaneous detection of the position of the peripheral edge of the semiconductor wafer and the phase position of the notch or the orientation mark.

The alignment apparatus described above may further include an optical camera that detects a portion for alignment formed on the outer periphery of the semiconductor wafer.

This configuration is effective in a case where a notch corresponding to a portion for alignment formed on an outer periphery of a semiconductor wafer is covered with a protective tape, and an evaporated metal component adheres to a bared adhesive face of the protective tape to hinder light from passing through the protective tape.

It is to be understood that both the foregoing general description and the following detailed description are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this specification, illustrate embodiments of the invention, and together with the description serve to explain the principles of the invention.

FIG. 1 shows a cutaway front view of an alignment apparatus according to a first embodiment of the present invention.

FIG. 2 shows a plan view of a holding stage of the alignment apparatus according to the first embodiment.

FIG. 3 shows a cutaway front view of an alignment apparatus according to a second embodiment of the present invention.

FIG. 4 shows a plan view of a holding stage of the alignment apparatus according to the second embodiment.

FIG. 5 shows a cutaway front view of an alignment apparatus according to a third embodiment of the present invention.

FIG. 6 shows a cutaway front view of an alignment apparatus according to a fourth embodiment of the present invention.

FIG. 7 shows a plan view of a holding stage of the alignment apparatus according to the fourth embodiment.

FIGS. 8A and 8B each show a front view of a process of transferring a semiconductor wafer in the alignment apparatus according to the fourth embodiment.

FIG. 9 shows a block diagram of the alignment apparatus according to each of the first to fourth embodiments.

### DESCRIPTION OF THE PREFERRED EMBODIMENTS

The present invention is described more fully hereinafter with reference to the accompanying drawings, in which embodiments of the invention are shown. The invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

One exemplary embodiment of the present invention will be described in detail hereinafter with reference to the drawings.

### First Embodiment

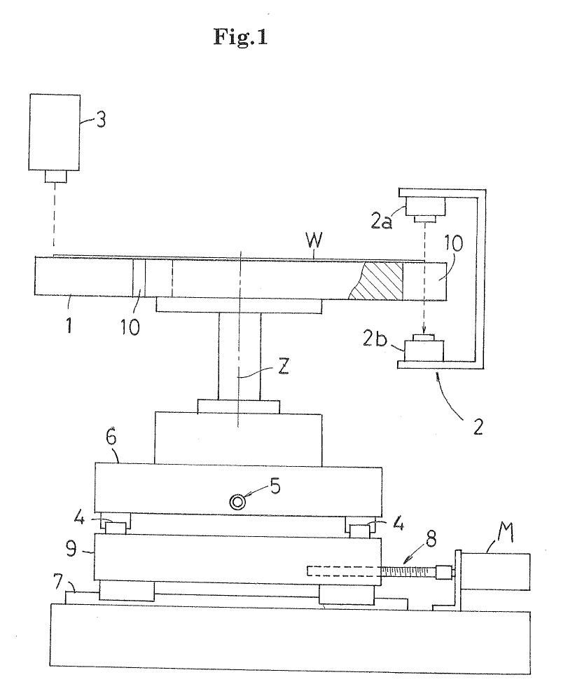

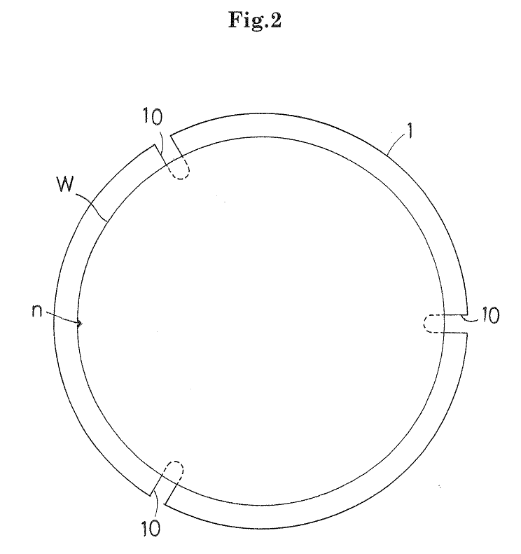

FIG. 1 shows a front view of an alignment apparatus according to a first embodiment of the present invention, and FIG. 2 shows a plan view of the alignment apparatus.

The alignment apparatus includes a holding stage 1 that suction-holds a semiconductor wafer (hereinafter, simply referred to as a “wafer”) W placed thereon, a photosensor 2 that detects a position of a peripheral edge of the wafer W, a CCD camera 3 that detects a phase position of a notch n for alignment formed on an outer periphery of the wafer W, and the like. Hereinafter, detailed description will be made of configurations of the respective constituent elements. It is to be noted that the CCD camera 3 corresponds to an optical camera according to the present invention.

The wafer W to be subjected to processing in the alignment apparatus has a surface on which a circuit pattern is formed, and the surface of the wafer W is covered with a protective tape. The wafer W is transferred from and to the alignment apparatus by a suction pad for transport or the like in such a manner that the suction pad suction-holds the surface of the wafer W, which is directed upward, from above.

The holding stage 1 is configured with a disc plate made of metal, and this disc plate is larger in diameter than the wafer W. The holding stage 1 is provided on an X-axis table 6 that is guided by a rail 4 and horizontally moves in a direction perpendicular to-the plane of FIG. 1 through a screw-feed type driving mechanism 5 coupled to a drive device such as a motor. Moreover, the holding stage 1 can rotate about a vertical axis Z corresponding to a center of the holding stage 1. The X-axis table 6 is mounted on a Y-axis table 9 that is guided by a rail 7 and horizontally moves in a direction parallel to the plane of FIG. 1 through a screw-feed type driving mechanism 8 coupled to a drive device M such as a motor.

As shown in FIG. 2, the holding stage 1 has a plurality (three in this embodiment) of small-width slits 10 formed thereon in a circumferential direction. The respective slits 10 extend toward the center of the holding stage 1 (the vertical axis Z), and the outer periphery of the wafer W placed on the holding stage 1 lies on part of the slits 10. Herein, the number of slits 10 is not particularly limited to three as long as a contour of the wafer W can be obtained by an arithmetic operation from information (e.g., a coordinate) obtained by measurement of the peripheral edge of the wafer W through the slits 10.

As shown in FIG. 1, the photosensor 2 is of a transparent type and includes a projector 2a and a photodetector 2b which are opposed to each other with the holding stage 1 interposed therebetween. The outer periphery of the wafer W placed on the holding stage 1 is located on a light emitting area of the photosensor 2. It is to be noted that the photosensor 2 corresponds to an optical sensor according to the present invention.

Next, description will be made of a process for performing alignment on the wafer W in the alignment apparatus described above.

First, the suction pad for transport suction-holds the surface of the wafer W and transfers the wafer W to the holding stage 1. The wafer W is suction-held through a plurality of vacuum-suction holes or an annular vacuum-suction groove formed thereon. Herein, the center of the wafer W is not necessarily aligned with the center of the holding stage 1. Further, the phase position of the notch n on the outer periphery of the wafer W is not fixed.

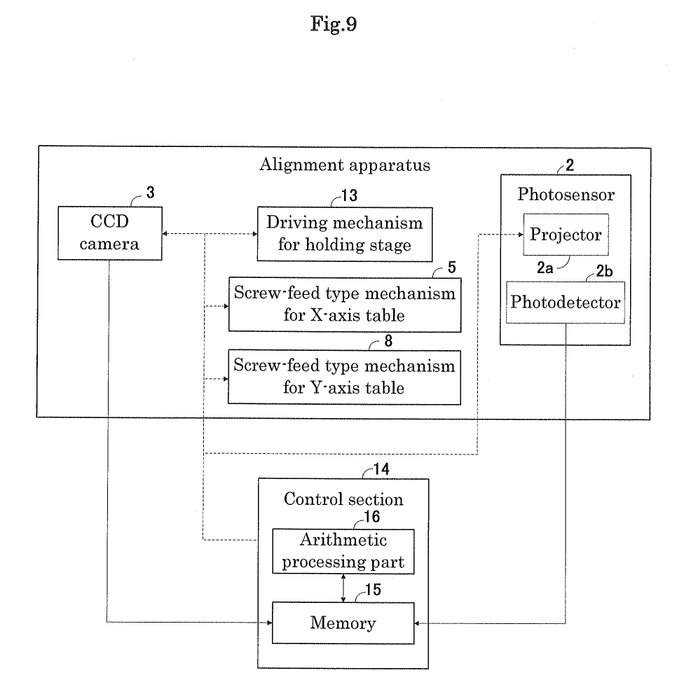

As shown in FIG. 9, next, a driving mechanism 13 such as a motor provided inside the X-axis table 6 turns the holding stage 1 one turn about the vertical axis Z corresponding to the center of the holding stage 1. During this rotation, the projector 2a of the photosensor 2 emits a light beam for detection. Since the slits 10 of the holding stage 1 extends to the light emitting area of the photosensor 2, the peripheral edge of the wafer W on the slits 10 cuts off the light beam to the photodetector 2b. A memory 15 of a control section 14 stores information about an area or a coordinate of the peripheral edge of the wafer W that lies on the slits 10 to cut off the light beam, and information about a phase position of the slits 10.

Based on the information about the position of the peripheral edge of the wafer W that lies on the slits 10 and the information about the phase position of the slits 10, an arithmetic processing part 16 of the control section 14 obtains a position of the center of the wafer W, a deviation of the position of the center of the wafer W relative to the position of the center of the holding stage 1 on the X-axis coordinate (i.e., in the direction perpendicular to-the plane), and a deviation of the position of the center of the wafer W relative to the position of the center of the holding stage 1 on the Y-axis coordinate (i.e., in the direction parallel to the plane).

The control section 14 controls the movement of the X-axis table 6 in accordance with the obtained deviation on the X-axis coordinate and also controls the movement of the Y-axis table 9 in accordance with the obtained deviation on the Y-axis coordinate to perform centering on the wafer W.

When the photosensor 2 measures the position of the peripheral edge of the wafer W, simultaneously, the CCD camera 3 captures an image of the peripheral edge of the wafer W. Herein, the CCD camera 3 detects the phase position of the notch n, and transmits information about this phase position to the control section 14 in which the memory 15 stores the information.

The control section 14 stores data about a reference image of the wafer W in advance, and compares data about the actually captured image with the data about the reference image (e.g., pattern matching) to calculate a deviation (an angle) of the notch n. Based on the deviation of the notch n, the control section 14 controls the rotation of the holding stage 1 while performing the centering on the wafer W to correct the position of the notch n to a reference phase position.

Thus, the process for performing the alignment on the wafer W is completed. Thereafter, the suction pad for transport suction-holds the surface of the wafer W, and transfers the wafer W from the holding stage 1.

### Second Embodiment

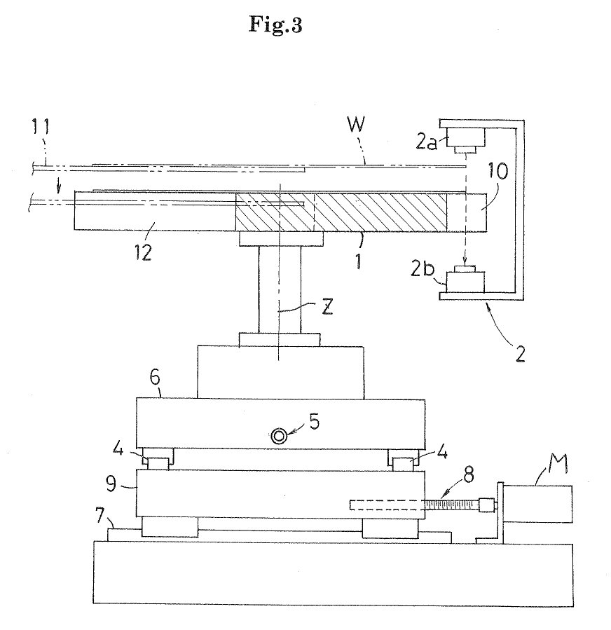

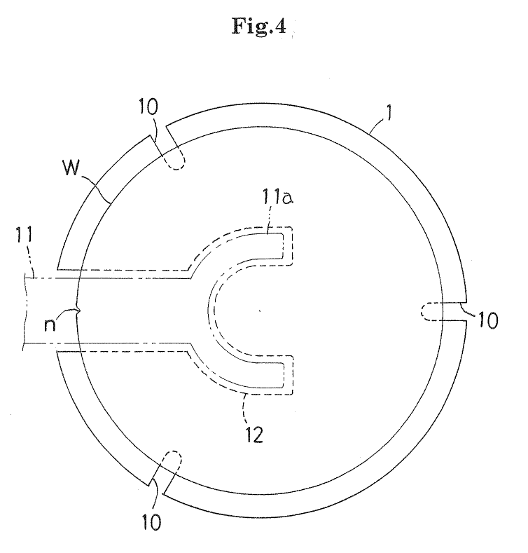

FIG. 3 shows a front view of an alignment apparatus according to a second embodiment of the present invention, and FIG. 4 shows a plan view of the alignment apparatus.

The alignment apparatus according to this embodiment is different from that according to the first embodiment in the manner to transport the wafer W and the configuration of the holding stage 1.

A wafer W to be subjected to processing in this embodiment has a surface on which a circuit pattern is formed. The wafer W is transferred from and to the alignment apparatus by a horseshoe-shaped suction holding part 11a provided at a tip end of a robot arm 11 in such a manner that the suction holding part 11a suction-holds a back face of the wafer W, which is directed upward, from below.

A holding stage 1 is configured with a disc plate made of metal, and this disc plate is larger in diameter than the wafer W. The holding stage 1 is provided on an X-axis table 6 that is guided by a rail 4 and horizontally moves in a direction perpendicular to-the plane of FIG. 3 through a screw-feed type driving mechanism 5 coupled to a drive device such as a motor. Moreover, the holding stage 1 can rotate about a vertical axis Z corresponding to a center of the holding stage 1 through a drive device such as a motor. The X-axis table 6 is mounted on a Y-axis table 9 that is guided by a rail 7 and horizontally moves in a direction parallel to the plane of FIG. 3 through a screw-feed type driving mechanism 8 coupled to a drive device M such as a motor.

As shown in FIG. 4, the holding stage 1 has a plurality (three in this embodiment) of small-width slits 10 formed thereon in a circumferential direction. The respective slits 10 extend toward the center of the holding stage 1 (the vertical axis Z), and an outer periphery of the wafer W placed on the holding stage 1 lies on part of the slits 10. The holding stage 1 also has a through cutout portion 12 formed thereon vertically, and the suction holding part 11a of the robot arm 11 vertically moves along the cutout portion 12.

As in the first embodiment, a photosensor 2 is of a transparent type and includes a projector 2a and a photodetector 2b which are opposed to each other with the holding stage 1 interposed therebetween. The outer periphery of the wafer W placed on the holding stage 1 is located on a light emitting area of the photosensor 2.

The alignment apparatus according to this embodiment is configured as described above. Next, description will be made of a process for performing alignment on the wafer W in the alignment apparatus.

First, the robot arm 11 that holds the wafer W moves to a position above the holding stage 1, and then moves downward along the cutout portion 12 of the holding stage 1. Then, the robot arm 11 cancels the vacuum-suction by the suction holding part 11a to place the wafer W on the holding stage 1. In this embodiment, the wafer W is subjected to alignment in advance such that a notch n thereof is superimposed on an arm portion of the robot arm 11.

When the holding stage 1 suction-holds the wafer W placed thereon, the robot arm 11 horizontally moves at a position under the holding stage 1, and then returns to an original position thereof.

As shown in FIG. 9, next, a driving mechanism 13 such as a motor provided inside the X-axis table 6 turns the holding stage 1 one turn about the vertical axis Z corresponding to the center of the holding stage 1. During this rotation, the projector 2a of the photosensor 2 emits a light beam for detection. Since the slits 10 of the holding stage 1 extends to the light emitting area of the photosensor 2, a peripheral edge of the wafer W on the slits 10 cuts off the light beam to the photodetector 2b. A memory 15 of a control section 14 stores information about an area or a coordinate of the peripheral edge of the wafer W that lies on the slits 10 to cut off the light beam, and information about a phase position of the slits 10.

Based on the information about the position of the peripheral edge of the wafer W that lies on the slits 10 and the information about the phase position of the slits 10, an arithmetic processing part 16 of the control section 14 obtains a position of a center of the wafer W, a deviation of the position of the center of the wafer W relative to a position of the center of the holding stage 1 on the X-axis coordinate (i.e., in the direction perpendicular to-the plane), and a deviation of the position of the center of the wafer W relative to a position of the center of the holding stage 1 on the Y-axis coordinate (i.e., in the direction parallel to the plane).

The control section 14 controls the movement of the X-axis table 6 in accordance with the obtained deviation on the X-axis coordinate and also controls the movement of the Y-axis table 9 in accordance with the obtained deviation on the Y-axis coordinate to perform centering on the wafer W.

The photosensor 2 measures the position of the peripheral edge of the wafer W, and simultaneously detects a phase position of the notch n on the cutout portion 12. The memory 15 of the control section 14 stores information about the detected phase position.

Based on the information about the phase position of the notch n, the control section 14 obtains a deviation (an angle) of the notch n relative to a preset reference phase position, and controls the rotation of the holding stage 1 while performing centering on the wafer W to correct the position of the notch n to the reference phase position.

Thus, the process for performing the alignment on the wafer W is completed. Thereafter, the robot arm 11 moves to the position under the holding stage 1, moves upward along the cutout portion 12 of the holding stage 1, suction-holds the back face of the wafer W from below, and transfers the wafer from the holding stage 1.

It is assumed herein that the wafer W including the notch n is covered with a transparent protective tape and an evaporated metal component adheres to a bared adhesive face of the protective tape to hinder a light beam from passing through the protective tape. In such a case, a CCD camera 3 may be used in place of the photosensor 2. More specifically, the CCD camera 3 captures an image of the notch n to identify the notch n by image analysis. In this configuration, it is preferable to emit the light beam to the notch n, capture a light beam reflected by the CCD camera 3, and then identify the notch n based on brightness variations. Alternatively, a white board may be provided at a position opposed to the CCD camera 3 with the notch n located therebetween. With this configuration, the CCD camera 3 can capture an image of an emphasized contour of the wafer W and can readily identify the notch n.

### Third Embodiment

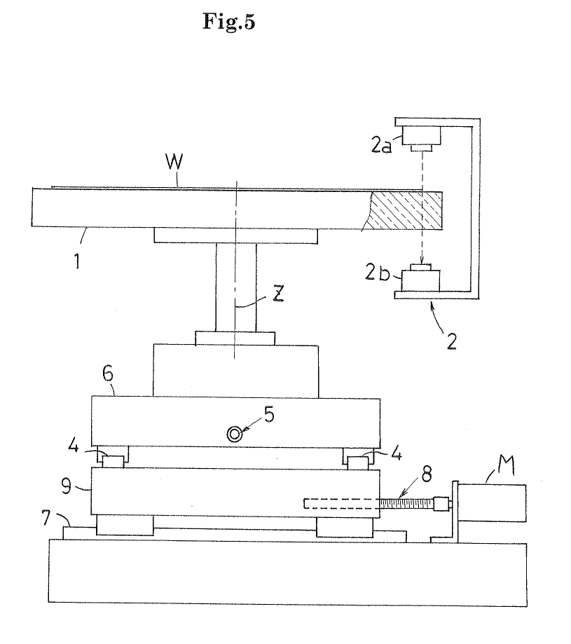

FIG. 5 shows a front view of an alignment apparatus according to a third embodiment of the present invention.

A wafer W to be subjected to processing in the alignment apparatus according to this embodiment has a surface on which a circuit pattern is formed, and the surface of the wafer W is covered with a protective tape. The wafer W is transferred from and to the alignment apparatus by a suction pad for transport or the like in such a manner that the suction pad suction-holds the surface of the wafer W, which is directed upward, from above.

A holding stage 1 is configured with a disc plate made of a solid and transparent material such as glass or resin, e.g., polycarbonate, and this disc plate is larger in diameter than the wafer W. The holding stage 1 has a plurality of vacuum-suction holes or an annular vacuum-suction groove formed thereon in order to suction-hold the wafer W.

As in the first embodiment, the holding stage 1 is provided on an X-axis table 6 that is guided by a rail 4 and horizontally moves in a direction perpendicular to-the plane of FIG. 5 through a screw-feed type driving mechanism 5 coupled to a drive device such as a motor. Moreover, the holding stage 1 can rotate about a vertical axis Z corresponding to a center of the holding stage 1. The X-axis table 6 is mounted on a Y-axis table 9 that is guided by a rail 7 and horizontally moves in a direction parallel to the plane of FIG. 5 through a screw-feed type driving mechanism 8 coupled to a drive device M such as a motor.

As in the first embodiment, a photosensor 2 is of a transparent type and includes a projector 2a and a photodetector 2b which are opposed to each other with the holding stage 1 interposed therebetween. An outer periphery of the wafer W placed on the holding stage 1 is located on a light emitting area of the photosensor 2.

With this configuration, the holding stage 1 rotates in the state that the entire back face of the wafer W comes into contact with the holding stage 1, and the projector 2a emits a light beam for detection. Accordingly, the photodetector 2b receives light passing through the holding stage 1 to simultaneously detect a position of the entire peripheral edge of the wafer W and a phase position of a notch n.

Based on information about the detected positions, an arithmetic processing part 16 of a control section 14 obtains a deviation of a position of a center of the wafer W relative to a position of the center of the holding stage 1 and a deviation of the phase position of the notch n from a reference phase position, and performs alignment on the wafer W as in the first and second embodiments.

### Fourth Embodiment

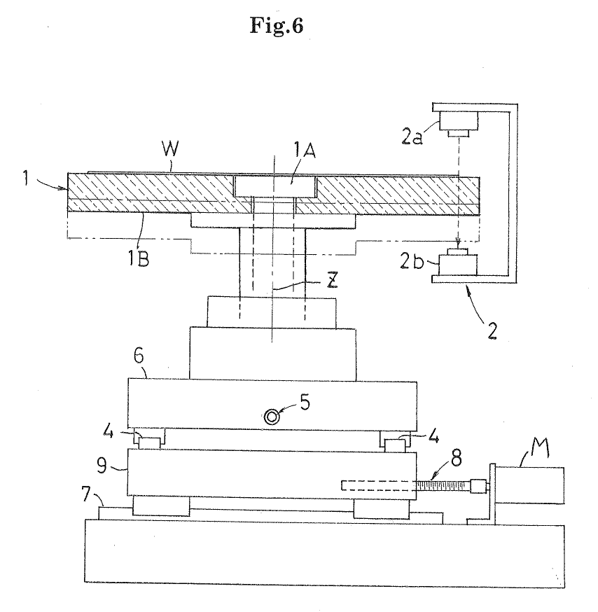

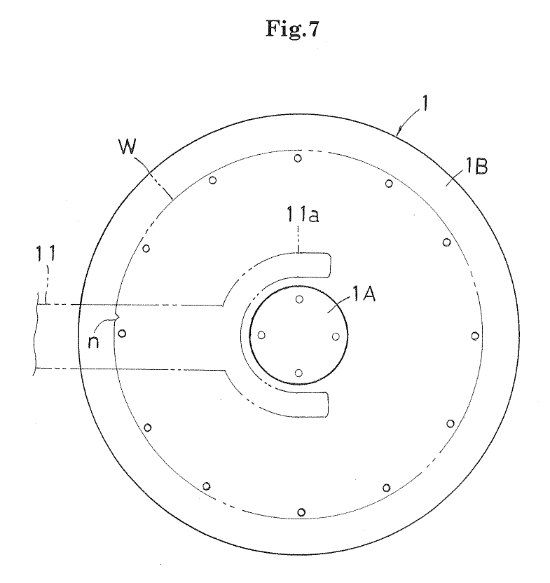

FIG. 6 shows a front view of an alignment apparatus according to a fourth embodiment of the present invention, and FIG. 7 shows a plan view of the alignment apparatus.

A wafer W to be subjected to processing in the alignment apparatus according to this embodiment has a surface on which a circuit pattern is formed. The wafer W is transferred from and to the alignment apparatus by a horseshoe-shaped suction holding part 11a provided at a tip end of a robot arm 11 in such a manner that the suction holding part 11a suction-holds a back face of the wafer W, which is directed upward, from below.

A holding stage 1 is larger in diameter than the wafer W as a whole. As in the first to third embodiments, the holding stage 1 is provided on an X-axis table 6 that is guided by a rail 4 and horizontally moves in a direction perpendicular to-the plane of FIG. 6 through a screw-feed type driving mechanism 5 coupled to a drive device such as a motor. Moreover, the holding stage 1 can rotate about a vertical axis Z corresponding to a center of the holding stage 1. The X-axis table 6 is mounted on a Y-axis table 9 that is guided by a rail 7 and horizontally moves in a direction parallel to the plane of FIG. 6 through a screw-feed type driving mechanism 8 coupled to a drive device M such as a motor.

As shown in FIG. 7, the holding stage 1 includes a small-diameter center portion 1A made of metal, and a wafer outer periphery placement portion 1B made of a solid and transparent material such as glass or resin, e.g., polycarbonate.

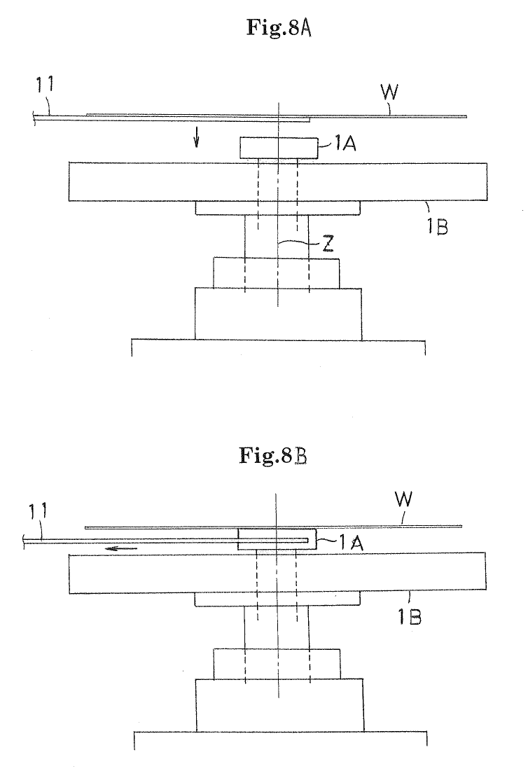

The center portion 1A has such a diameter that the horseshoe-shaped suction holding part 11a of the robot arm 11 can be engaged therewith. Moreover, the wafer outer periphery placement portion 1B can move vertically. That is, the holding stage 1 can be switched between a wafer transfer state in which the wafer outer periphery placement portion 1B moves downward so that the center portion 1A protrudes upward as shown in FIGS. 8A and 8B and a wafer placement state in which the center portion 1A and the wafer outer periphery placement portion 1B are flush with each other as shown in FIG. 6.

As in the first embodiment, a photosensor 2 is of a transparent type and includes a projector 2a and a photodetector 2b which are opposed to each other with the holding stage 1 interposed therebetween. An outer periphery of the wafer W placed on the holding stage 1 is located on a light emitting area of the photosensor 2.

According to this configuration, first, the wafer outer periphery placement portion 1B moves downward as shown in FIG. 8A. Herein, the holding stage 1 is in the wafer transfer state in which the center portion 1A protrudes upward. In this state, the robot arm 11 that suction-holds the wafer W moves to a position above the holding stage 1.

As shown in FIG. 8B, next, the robot arm 11 moves downward while canceling the suction-holding of the wafer W by the suction holding part 11a, and then places the wafer W on the center portion 1A. Thereafter, the wafer outer periphery placement portion 1B moves upward so as to be flush with the center portion 1A, so that the holding stage 1 is in the wafer placement state. Thus, the holding stage 1 holds the wafer W in such a state that the entire back face of the wafer W comes into contact with the holding stage 1.

Next, a control section 14 turns the holding stage 1 that holds the wafer W placed thereon, and allows the projector 2a to emit a light beam for detection. Then, the photodetector 2b receives light passing through the wafer outer periphery placement portion 1B to detect a position of the entire peripheral edge of the wafer W and a phase position of a notch n on the wafer W.

Based on information about the detected positions, an arithmetic processing part 16 of the control section 14 obtains a deviation of a position of a center of the wafer W relative to a position of the center of the holding stage 1 and a deviation of the phase position of the notch n from a reference phase position, and performs alignment on the wafer W as in the first to third embodiments.

The present invention is not limited to only the exemplary embodiment described above, and may be embodied in accordance with the following modifications.

In the exemplary embodiments described above, an object to be subjected to processing is the wafer W having the surface on which the circuit pattern is formed and to which the protective tape is joined. In the alignment apparatus according to each of the second to fourth embodiments, however, the robot arm 11 transports the wafer W in the state that the suction-holding part 11a suction-holds the back face of the wafer W. Therefore, the alignment apparatus can perform alignment on a wafer to which no protective tape is joined.

Moreover, it is assumed in the first embodiment that the wafer W is placed on the holding stage 1 in a state that the notch n is located on the slits 10 in advance by alignment. In this case, the notch n may be detected using only the photosensor 2 without use of the CCD camera 3.

It will be apparent to those skilled in the art that various modifications and variations can be made in the present invention without departing from the spirit or scope of the invention. Thus, it is intended that the invention cover the modifications and variations of the invention provided they come within the scope of the appended claims and their equivalents.

What is claimed is:

1. An alignment apparatus for performing alignment on a semiconductor wafer, based on information about a peripheral edge of the semiconductor wafer,
the alignment apparatus comprising:
a holding stage that is larger in size than a semiconductor wafer;
an optical sensor that optically detects a position of a peripheral edge of the semiconductor wafer placed on and suction-held by the holding stage;
a driving mechanism that turns the holding stage; and
a control section that performs alignment on the semiconductor wafer, based on the position detected by the optical sensor.

2. The alignment apparatus according to claim 1, wherein
the holding stage has a plurality of slits formed thereon vertically in a circumferential direction such that an outer periphery of the semiconductor wafer lies on the slits, and
the optical sensor is of a transparent type and includes a projector and a photodetector opposed to each other with the slit interposed therebetween.

3. The alignment apparatus according to claim 1, wherein
the holding stage has a cutout portion formed thereon such that a suction holding part provided at a tip end of a robot arm for transport of the semiconductor wafer vertically moves along the cutout portion.

4. The alignment apparatus according to claim 3, wherein
the cutout portion vertically penetrates through the holding stage.

5. The alignment apparatus according to claim 1, wherein
the holding stage has a region where at least the outer periphery of the semiconductor wafer is placed, the region being made of a transparent material, and
the optical sensor is of a transparent type and includes a projector and a photodetector opposed vertically to each other with the holding stage interposed therebetween.

6. The alignment apparatus according to claim 5, wherein
the holding stage includes a center portion where a center of the semiconductor wafer is placed, and a ring-shaped periphery portion that is made of a transparent material and surrounds the center portion, and
the center portion and the wafer outer periphery placement portion relatively move upward and downward such that the holding stage is switched between a wafer transfer state in which the center portion protrudes upward from the wafer outer periphery placement portion and a wafer placement state in which the center portion and the wafer outer periphery placement portion are flush with each other.

7. The alignment apparatus according to claim 5, wherein
the transparent material is glass.

8. The alignment apparatus according to claim 5, wherein
the transparent material is polycarbonate.

9. The alignment apparatus according to claim 1, further comprising
an optical camera that detects a portion for alignment formed on the outer periphery of the semiconductor wafer.
